(19) United States
(12) Patent Application Publication
(10) Pub. No.: US 2026/0136424 A1
(43) Pub. Date: May 14, 2026

(54) TOKEN-BASED WIRELESS ACCESS NETWORK CONNECTION AUTHORIZATION FOR NETWORK IMPAIRMENTS

(71) Applicants: AT&T Intellectual Property I, L.P., Atlanta, GA (US); AT&T Mobility II LLC, Atlanta, GA (US)

(72) Inventors: Sreejith Menon, Herndon, VA (US); Suja John, Herndon, VA (US)

(21) Appl. No.: 18/948,451

(22) Filed: Nov. 14, 2024

(51) Int. Cl. H04W 76/18; H04W 12/06; H04W 76/40

(52) U.S. Cl. CPC H04W 76/18; H04W 12/06; H04W 76/40

(57) ABSTRACT

A processing system including at least one processor in a wireless access network may detect a network impairment in the wireless access network. The processing system may next obtain a first network connection request from a first mobile endpoint device, reject the first network connection request, and provide a first access token to the first mobile endpoint device. The processing system may then obtain a second network connection request from the first mobile endpoint device, where the second network connection request includes the first access token, and establish a network connection for the first mobile endpoint device, in response to the second network connection request including the first access token.

The present disclosure relates generally to wireless communication networks, and more particularly to methods, non-transitory computer-readable media, and apparatuses for providing a first access token to a first mobile endpoint device in response to rejecting a first network connection request and obtaining a second network connection request from the first mobile endpoint device that includes the first access token, and to methods, non-transitory computer-readable media, and apparatuses for obtaining an access token when a first network connection request is rejected by a wireless access network and transmitting a second network connection request that includes the access token.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance.

### SUMMARY

In one example, the present disclosure discloses a method, computer-readable medium, and apparatus for providing a first access token to a first mobile endpoint device in response to rejecting a first network connection request and obtaining a second network connection request from the first mobile endpoint device that includes the first access token. For example, a processing system including at least one processor in a wireless access network may detect a network impairment in the wireless access network. The processing system may next obtain a first network connection request from a first mobile endpoint device, reject the first network connection request, and provide a first access token to the first mobile endpoint device. The processing system may then obtain a second network connection request from the first mobile endpoint device, where the second network connection request includes the first access token, and establish a network connection for the first mobile endpoint device, in response to the second network connection request including the first access token.

In one example, the present disclosure also discloses a method, computer-readable medium, and apparatus for obtaining an access token when a first network connection request is rejected by a wireless access network and transmitting a second network connection request that includes the access token. For example, a processing system including at least one processor of a mobile endpoint device may transmit a first network connection request to a wireless access network and obtain an access token for use in a subsequent network connection request, where the first network connection request is rejected by the wireless access network. The processing system may then transmit a second network connection request in accordance with the access token, where the second network connection request includes the access token. In addition, the processing system may establish a network connection with the wireless access network when the second network connection request is accepted by the wireless access network in accordance with the access token.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for providing a first access token to a first mobile endpoint device in response to rejecting a first network connection request and obtaining a second network connection request from the first mobile endpoint device that includes the first access token;

FIG. 3 illustrates a flowchart of an example method for obtaining an access token when a first network connection request is rejected by a wireless access network and transmitting a second network connection request that includes the access token; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for providing a first access token to a first mobile endpoint device in response to rejecting a first network connection request and obtaining a second network connection request from the first mobile endpoint device that includes the first access token. The present disclosure also broadly discloses methods, computer-readable media, and apparatuses for obtaining an access token when a first network connection request is rejected by a wireless access network and transmitting a second network connection request that includes the access token. In particular, examples of the present disclosure provide new techniques for wireless access network (e.g., cellular radio access network (RAN)) utilization optimization through software-defined radio resource partitioning using a unique token-based queueing and paging system. To further illustrate, examples of the present disclosure may provide for priority access to mobile endpoint devices that were unable to obtain network access based upon an initial connection attempt, e.g., due to congestion or other network impairments. In other words, these mobile endpoint devices may be first in line to be permitted to reattempt network connection/attachment as soon as network resources become available. This targeted approach minimizes the uplink noise generated by mobile endpoint devices repeatedly trying to reattach, and enhances user experience by reducing wait times. In one example, the present disclosure may integrate artificial intelligence (AI) and/or machine learning (ML) functions, e.g., to create and deploy a predictive model or models for accurate forecasting/prediction of future network resource availability. In one example, the present disclosure may further incorporate quality of service (QoS) and/or service level agreements considerations to adjust priority queueing (e.g., applying selective modifications to a strictly first-in/first-out (FIFO) queuing).

Notably, when a wireless access network is congested, cell sites/base stations may impose connection/attachment rejections (e.g., Radio Resource Control (RRC) rejections) or access class barring on some or all mobile endpoint devices (e.g., user equipment (UE)) attempting to connect/attach to a cell site/base station. For instance, these types of measures may be warranted to maintain wireless access network stability and to help ensure that high-priority mobile endpoint devices, such as mobile endpoint devices of first responders, can communicate via the wireless access network. However, when a non-first responder mobile endpoint device (or other non-priority mobile endpoint devices) receives a RRC rejection message, the mobile endpoint device may continue to attempt network connections, or to execute reattach procedures (e.g., periodically or otherwise). This creates considerable uplink noise on the wireless access network and diminishes mobile endpoint device battery life. For instance, a first mobile endpoint device may attempt to register with the wireless access network at 16:45 and may be rejected due to congestion. According to 3^{rd} Generation Partnership Project (3GPP) defined procedures, the first mobile endpoint device may wait approximately five minutes before attempting to reconnect/reattach. If network resources of the wireless access network become available that are sufficient to accommodate a single mobile endpoint device within a time interval, and another mobile endpoint device attempts to connect/attach, the other mobile endpoint device may gain access instead, while the first mobile endpoint device may continue to be blocked. This can lead to inefficiency as well as user frustration.

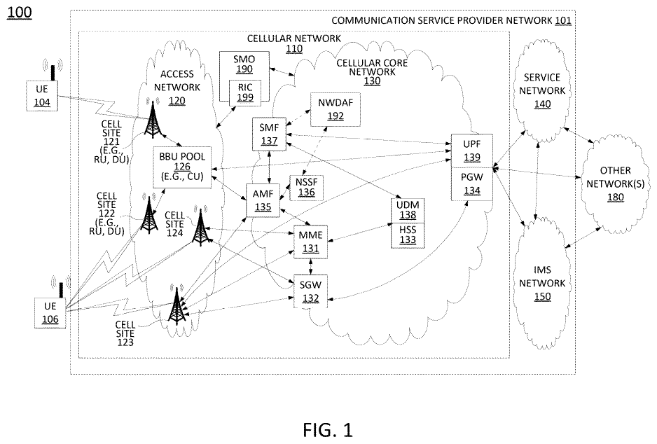

In contrast, examples of the present disclosure provide for token-based queueing and paging within the wireless access network in situations of network congestion/impairment. For example, when the wireless access network (e.g., a cell site/base station) determines that it is in an impaired/congested condition and may be unable to support network connections from all mobile endpoint devices that may be connected/attached or that may seek to connect/attach, the wireless access network may still select one or more mobile endpoint devices for connection rejection (e.g., RRC reject messages) and/or access class barring. However, in conjunction with the connection rejections, these “rejected” mobile endpoint devices may be assigned respective access tokens, e.g., token numbers, as part of or accompanying the connection reject messages (e.g., RRC reject messages). In addition, when the wireless access network has enough bandwidth or other resources available to accommodate one or more of these rejected mobile endpoint devices, the wireless access network may selectively page the rejected mobile endpoint device(s) with the corresponding token(s) to attempt reconnection/reattachment. Examples of the present disclosure therefore provide for a first-in/first-out, or substantially first-in/first-out procedure rather than a round-robin, random, or endpoint device-centric greedy approach, thereby streamlining the reconnection/reattachment process, reducing additional signaling load on the wireless access network, and improving overall user experience. In particular, the token-based paging/authorization of the present disclosure helps to reduce the uplink signaling noise created by mobile endpoint devices repeatedly attempting to connect/re-attach to the wireless access network, helps in preserving endpoint device battery life, and provides a more equitable prioritization to connect/attach based on a time since a mobile endpoint device was first rejected/blocked. These and other aspects of the present disclosure are discussed in greater detail below in connection with the examples of FIGS. 1-4.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include radio units (RUs)/RRHs, distributed units (DUs), and centralized units (CU) (e.g., where baseband units (BBUs) may include CUs and/or CUs in conjunction with DUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

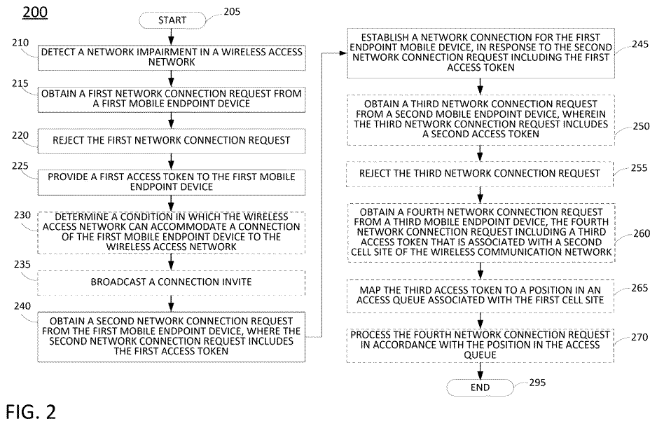

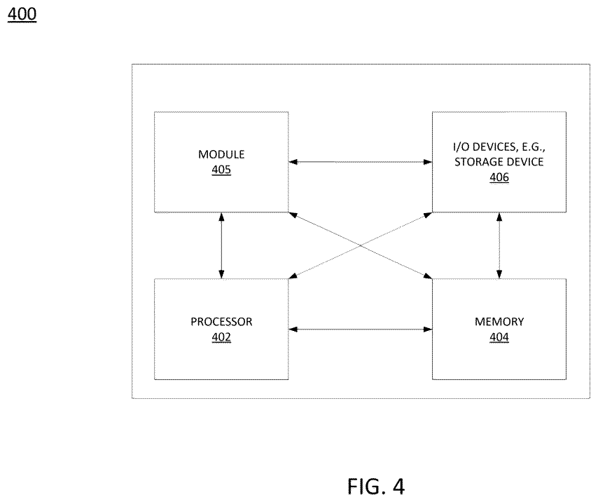

Furthermore, in accordance with the present disclosure, a base station (e.g., cell sites 121-124 and/or baseband units within BBU pool 126) or a portion thereof (e.g., a CU, a DU, or a CU in conjunction with a DU) may comprise all or a portion of a computing system, such as computing system 400 as depicted in FIG. 4, and may be configured to provide one or more functions in connection with examples of the present disclosure for providing a first access token to a first mobile endpoint device in response to rejecting a first network connection request and obtaining a second network connection request from the first mobile endpoint device that includes the first access token, such as illustrated and described in connection with the example method 200 of FIG. 2.

In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

To further illustrate, an example cell site/base station, such as cell site 121 may detect a network impairment, e.g., congestion and/or lack of capacity of itself and/or an air interface of access network 102, etc. For instance, cell site 121 may track its own performance indicators, such as processor and memory capacity and/or utilization, air interface/wireless channel availability (e.g., bandwidth utilization and/or availability), uplink noise metrics, downlink noise metrics, a number of attached endpoint devices, a number of connection attempts and/or attachment attempts, e.g., in one or more time periods, a rate of connection and/or attachment attempts, a call drop rate, a call failure rate, a connection drop rate, a connection failure rate, and so forth. Alternatively, or in addition, cell site 121 may obtain a notification of network impairment from another network component, such as NWDAF 192, SMO 190 and/or RIC 199, or the like. For instance, another network entity may collect network performance data (including performance data of access network 120, e.g., RAN performance data) and may detect a network impairment or may forecast a network impairment at a future time period. In addition, the other network entity may transmit a notification of the impairment to cell site 121 and/or may transmit an instruction to cell site 121 to implement access class blocking, selective connection/attachment rejection, etc. The network impairment (forecast or detected) may be with respect to cell site 121 directly, may be with respect to one or more other cell sites (which may impact the load on cell site 121, e.g., which may accommodate additional traffic from the directly affected cell site(s)), may be with respect to a backhaul within access network 120 and/or a portion of the cellular core network 130, and so forth. For example, NWDAF192 and/or SMO 190 may determine that it is desirable to rate-limit traffic from access network 120 to the cellular core 130.

In any case, cell site 121 may then obtain a network connection request (e.g., an RRC connection request) from a mobile endpoint device (e.g., UE 104, or the like). However, in response to the network impairment, cell site 121 may block one or more new connections/connection requests. For instance, in the present example, cell site 121 may reject the connection request from UE 104. However, cell site 121 may also provide a first access token to UE 104 for subsequent use in connecting/attaching to access network 120 and/or cellular network 110 via cell site 121. The access token may indicate a hold-off time period or may indicate a position in a priority queue associated with cell site 121 (e.g., and maintained/implemented by cell site 121).

In one example, cell site 121 may detect a condition in which cell site 121 can accommodate one or more new endpoint device connections. In one example, cell site 121 may broadcast an invitation to one or more endpoint devices to attempt to attach/connect to cell site 121). For instance, the invitation may indicate a range of one or more tokens (e.g., a range of token values associated with a plurality of tokens, or other grouping classifications, e.g., “group 1” tokens, “group 2” tokens, etc.) that are permitted/authorized for use in obtaining connection/attachment to cell site 121. Accordingly, in the present example, cell site 121 may obtain a subsequent network connection request from UE 104 when the access token held by UE 104 falls within the indicated range or classification. In one example, UE 104 may include the first access token in the subsequent connection request (e.g., a RRC connection request message) such that the cell site 121 may verify that the UE 104 is part of the authorized group of UEs/access tokens. If so, cell site 121 may then, in response to verifying that the network attach request includes the first access token, establish a network connection for UE 104 (e.g., completing a RRC connect procedure, security process, protocol data unit (PDU) session establishment, etc.).

Alternatively, or in addition, where the access token indicates a hold-off time period, the UE 104 may transmit a subsequent network connection request to cell site 121 only after the expiration of the hold-off time period (where the network connection request may include the access token). In one example, cell site 121 may extract the access token from the network connection request to verify that the hold-off time period associated therewith has expired. If so, cell site 121 may then, in response to verifying that the network attach request includes the first access token, establish a network connection for UE 104 (e.g., completing a RRC connect procedure, security process, protocol data unit (PDU) session establishment, etc.). Additional operations that may be performed by a cell site, such as cell site 121, are described in greater detail below in connection with the example method 200 of FIG. 2.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126. In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-124. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and any future generation of wireless cellular technology, e.g., 6G the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 192.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 192, which may be tasked with monitoring various network functions, network slices, and access network components. In one example, NWDAF 192 may subscribe to data analytics (e.g., performance indicators/KPIs) from a variety of NFs, may store these analytics, and may provide such analytics to other NFs that may request such data. In accordance with the present disclosure, NWDAF 192 may track various performance indicators with respect to access network 120 and/or regarding particular components thereof (such as RUs, DUs, CU, etc., e.g., cell sites 121 and 122, BBU pool 125, cell sites 123 and 124, and so forth). In one example, NWDAF 192 may also collect and store external/third-party data, such as weather data (e.g., temperature, humidity, precipitation indication, precipitation volume, etc.) that may also be used in connection with predicting/forecasting network impairment relating to access network 120 and/or portions thereof (e.g., at one or more of cell sites 121-123).

In one example, NWDAF 192 may also train and store one or more network impairment detection/forecasting models. For instance, the network impairment detection/forecasting model(s) may each comprise a machine learning model. It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, NWDAF 192 may train and deploy one or more such network impairment detection/forecasting models. For example, NWDAF 192 may train and deploy different network impairment detection/forecasting models for different geographic regions (e.g., states, groups of states, etc.), for different tracking areas, for different equipment types, for different deployment types (e.g., rooftop versus non-rooftop/standalone), and so on. Alternatively, or in addition, these factors may comprise additional inputs/predictors for a trained MLM, where the MLM may learn and generate outputs based upon the relevance of these different inputs/predictors.

To further illustrate, in one example, NWDAF 192 may apply an input vector comprising RAN performance data associated with cell site 121 to a network impairment detection/forecasting model to generate an output indicating whether cell site 121 is experiencing and/or is predicted to exhibit a network impairment at a future time period. In this regard, it should be noted that in one example, such a network impairment detection/forecasting model may be trained/configured to output a prediction of a level of network impairment (e.g., slight impairment, moderate impairment, significant impairment, severe impairment, or the like). Alternatively, or in addition, the network impairment detection/forecasting model may be trained/configured to output a recommended maximum number of RRC connections and/or a maximum number of endpoint devices to be permitted to attach to cell site 121, or the like (e.g., at a present or future time period). In this regard, it should also be noted that in some cases, the output of the network impairment detection/forecasting model may forecast or detect a network load (where some network loads may indicate “impairment” while others may indicate normal or “non-impaired” operations at cell site 121 and/or access network 120 more generally). In one example, NWDAF 192 may implement multiple models, e.g., a pipeline of MLMs, or the like for an overall purpose. For instance, a first MLM may predict a number of endpoint devices that may be present in a given area (e.g., at a cell site) at a future time period, while a second MLM may predict whether a network impairment may be exhibited at such time period, e.g., based at least in part upon the number of endpoint devices predicted via the first MLM.

In one example, NWDAF 192 may provide individual or aggregate reports to one or more other NFs, e.g., on a subscription basis and/or on-demand. For instance, SMO 190 and/or RIC 199 thereof may obtain cell site impairment/load alerts, reports, or the like from NWDAF 192, and may use such information to automatically configure/reconfigure one or more aspects of cell site 121 and/or access network 120. Likewise, in one example NWDAF 192 may provide alerts, reports, or the like to cell site 121 (and/or other cell sites) to enable the cell site(s) to implement token-based access mechanisms or other remedial measures in response to detected and/or forecast network impairments (e.g., load/capacity conditions that may benefit from RRC connection establishment metering/management).

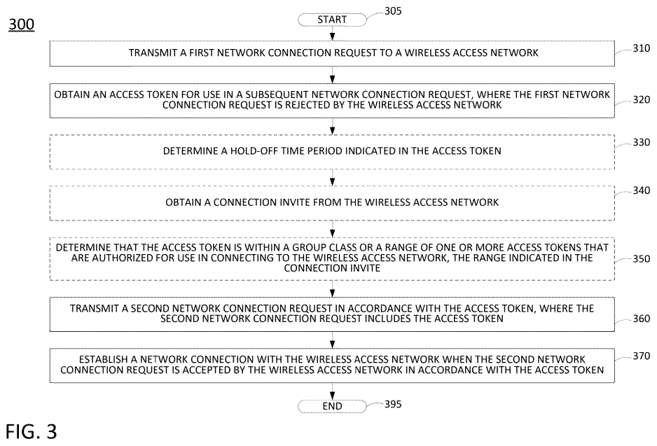

In one example, NWDAF 192 may comprise all or a portion of a computing device or system, such as computing system 400, and/or processing system 402 as described in connection with FIG. 4 below, and may be configured to perform various operations in connection with examples of the present disclosure for providing a first access token to a first mobile endpoint device in response to rejecting a first network connection request and obtaining a second network connection request from the first mobile endpoint device that includes the first access token (e.g., as illustrated and described in connection with the example of FIG. 2) and/or for obtaining an access token when a first network connection request is rejected by a wireless access network and transmitting a second network connection request that includes the access token (e.g., as illustrated and described in connection with the example of FIG. 3).

In one example, cellular network 110 may comprise a “non-stand alone” (NSA) mode architecture, where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, in another example, the present disclosure may relate to a hybrid, or integrated 4G/LTE-5G cellular core network, such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various mobile endpoint devices, e.g., user equipment (UE) 104 and 106. UE 104 and 106 may each comprise a cellular telephone, a smartphone, a tablet computing device, a laptop computer, a pair of computing glasses, a pair of wireless goggles, a wireless enabled wristwatch, a wireless transceiver for a fixed wireless broadband (FWB) deployment, or any other cellular-capable mobile telephony and computing devices (broadly, “a mobile endpoint device”). In one example, each of the UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

As illustrated in FIG. 1, UEs 104 and 106 may register and attach to any of cell sites 121-124 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the selected cell site and establish a radio resource control (RRC) communication, transmitting a registration/attach request, performing authentication procedures, establishing a default protocol data unit (PDU) session, e.g., including bearer assignment, and so forth. However, as described in greater detail herein, in some cases the selected cell site/base station may reject a connection request. For instance, cell site 121 may transmit a RRC reject message in response to an RRC connection request from UE 104, or the like. In one example, the RRC reject message may include an access token that the UE 104 may then use in a subsequent attempt to connect/attach to cellular network 110 via cell site 121 (or in one example, via a different cell site). For instance, the access token may indicate a hold-off time period after which UE 104 may be permitted to attempt to reconnect/reattach to the cellular network 110 via cell site 121, or may be associated with a place/position in an access queue for permitting endpoint devices to connect/attach to cell site 121, (e.g., where the cell site 121 may subsequently broadcast or otherwise transmit an invitation to UE 104 to attempt to connect/attach to the cell site 121 when the cell site 121 is able to accommodate such a connection/attachment and in accordance with the position of UE 104 in the queue (e.g., in accordance with the token priority/position in the queue)).

Furthermore, in accordance with the present disclosure, an endpoint device (e.g., UE 104, UE 106, or the like) or a portion thereof may comprise all or a portion of a computing system, such as computing system 400 as depicted in FIG. 4, and may be configured to provide one or more functions in connection with examples of the present disclosure for obtaining an access token when a first network connection request is rejected by a wireless access network and transmitting a second network connection request that includes the access token, such as illustrated and described in connection with the example method 300 of FIG. 3.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, RIC 199 may comprise a platform that hosts various RAN applications (e.g., xApps/rApps) that may be used to configure and reconfigure various components of access network 120. In one example, aspects of RIC 199 may represent functionality of an SON orchestrator, or vice versa. In one example, RIC 199 and/or SMO 190 may request and/or subscribe to various information that may be obtained and stored by NWDAF 192. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 199 and/or SMO 190 may obtain various information from RAN components or other network elements directly (e.g., without NWDAF 192 as an intermediary).

In one particular example, as noted above SMO 190 may subscribe to or otherwise obtain network load/network impairment alerts, reports, or the like from NWDAF 192. For instance, the network load/network impairment alerts may indicate one or more cell sites/base stations being affected, the magnitude (e.g., 25% reduction in capacity, 50% reduction in capacity, or the like, a maximum number of RRC connections and/or attached endpoint devices that can be supported at a sector, cell site, or the like), and/or the anticipated duration of the impairment, etc. Alternatively, or in addition, SMO 190 may obtain from NWDAF 192 one or more alerts, reports, etc. indicating an impairment to a backhaul portion of access network 120, a network slice of cellular core network 130 and/or one or more components of cellular core network 130 affected by a network impairment, and so forth. In such case, SMO 190 and/or RIC 199 may then identify one or more access network components that may be reconfigured to alleviate or otherwise address the conditions in the backhaul and/or cellular core network 130. For instance, as noted above, in one example, the present disclosure may implement access class blocking, selective RRC connection rejection, or the like, e.g., to rate limit traffic from a RAN to a cellular core network.

Accordingly, SMO 190 and/or RIC 199 may then configure/reconfigure one or more aspects of access network 120, cellular core network 130, and/or one or more network slices deployed over the infrastructure of access network 120 and cellular core network 130. For instance, SMO 190 and/or RIC 199 may transmit an alert and/or instructions to one or more of cell sites 121-124 and/or BBU pool 126 to implement token-based access mechanisms or other remedial measures in response to detected and/or forecast network impairments (e.g., load/capacity conditions that may benefit from RRC connection establishment blocking, metering, and/or rate-limiting).

In one example, RIC 199 and/or SMO 190 may comprise all or a portion of a computing device or system, such as computing system 400, and/or processing system 402 as described in connection with FIG. 4 below, and may be configured to perform various operations in connection with examples of the present disclosure for providing a first access token to a first mobile endpoint device in response to rejecting a first network connection request and obtaining a second network connection request from the first mobile endpoint device that includes the first access token (e.g., as illustrated and described in connection with the example of FIG. 2) and/or for obtaining an access token when a first network connection request is rejected by a wireless access network and transmitting a second network connection request that includes the access token (e.g., as illustrated and described in connection with the example of FIG. 3). In this regard, it should also be noted that in some examples, aspects described herein with respect to NWDAF 192 may alternatively or additionally be performed by SMO 190 and/or RIC 199. For instance, in one example, SMO 190 may implement one or more network impairment detection/forecasting models. To further illustrate, NWDAF 192 may collect and store RAN performance indicators. SMO 190 and/or RIC 199 may then obtain these records and may apply the records to one or more network impairment detection/forecasting models in accordance with the present disclosure to detect network impairments and/or to predict/forecast network loads at one or more future time periods. In addition, SMO 190 and/or RIC 199 may then configure/reconfigure one or more aspects of network 120, cell site 121, etc. in response to the network impairment(s)/network load(s) detected and/or forecast.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above.

In addition, network elements or functions that are illustrating as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. Thus, these and other modifications are all contemplated within the scope of the present disclosure.

FIG. 2 illustrates a flowchart of an example method 200 for providing a first access token to a first mobile endpoint device in response to rejecting a first network connection request and obtaining a second network connection request from the first mobile endpoint device that includes the first access token, in accordance with the present disclosure. In one example, steps, functions and/or operations of the method 200 may be performed by a device as illustrated in FIG. 1, e.g., a processing system comprising a cell site, a base station, a BBU, a CU, a DU, etc., or collectively via a plurality devices in FIG. 1, such as a base station, a BBU, a CU, a DU, etc., in conjunction with a different one of such components and/or any one or more other components in FIG. 1, such as NWDAF 192, SMO 190 and/or RIC 199, etc. In one example, the steps, functions, or operations of method 200 may be performed by a computing device or system 400, and/or a processing system 402 as described in connection with FIG. 4 below. For instance, the computing device 400 may represent at least a portion of a cell site, a base station, a BBU, a CU, a DU, etc. in accordance with the present disclosure. For illustrative purposes, the method 200 is described in greater detail below in connection with an example performed by a processing system, such as processing system 402. The method 200 begins in step 205 and proceeds to step 210.

At step 210, the processing system, e.g., deployed in a wireless access network (such as a processing system of a first cell site/base station, BBU, CU, DU, or the like) detects a network impairment in the wireless access network. For instance, the network impairment may comprise at least one of: an outage of at least a portion of the wireless access network, a network congestion condition in the wireless access network, or an emergency condition in which additional resources of the wireless access network are dedicated to a priority network slice for first responders, etc. In various examples, the processing system may detect the network impairment based upon its own collection and evaluation of one or more wireless access network performance indicators. Alternatively, or in addition, the processing system may obtain a notification of the network impairment from another automated system, such as a NWDAF, a SMO, a RIC, or the like.

At step 215, the processing system obtains a first network connection request from a first mobile endpoint device (e.g., to attach to a particular cell site/base station comprising the processing system and/or in which the processing system is a component thereof/deployed therein (e.g., a “first cell site”)). For instance, in one example, the first network connection request may comprise a RRC connection request, e.g., directed to the first cell site/base station.

At step 220, the processing system rejects the first network connection request. For instance, the processing system may determine, e.g., in response to the network impairment, to implement access class blocking (e.g., where the first mobile endpoint device is part of a designated class), selective RRC connection blocking (or connection request rejection), or the like. In one example, the detection of the impairment at step 210 may include obtaining an instruction, e.g., from a SMO, RIC, or the like, to limit a number of mobile endpoint devices attaching to the first cell site and/or specifically to limit/block a number or percentage of RRC connection requests. In one example, step 220 may include selecting the first mobile endpoint device for network connection request blocking. For instance, the processing system may randomly select the first mobile endpoint device, e.g., in accordance with a blocking selecting probability or the like. In another example, all new network connection requests may be blocked/denied, where the requesting mobile endpoint devices may be assigned to positions in a access queue as described herein.

At step 225, the processing system provides a first access token to the first mobile endpoint device. In one example, step 225 may include selecting a next access token or a next sequential value indicating a position in an access priority queue with respect to other access tokens and/or other endpoint devices that may be assigned/associated with the other access tokens. In one example, the first access token may be associated with or may indicate a time of the connection rejection (e.g., a time stamp). Alternatively, or in addition, the first access token may indicate a first hold-off time period. In one example, the first hold-off time period may be selected based upon a level of a congestion condition (e.g., in the wireless access network, such as at the first cell site/base station associated with the processing system, one or more nearby base stations/cell sites, and/or within at least a portion of a cellular core network). In one example, the access token may comprise a sequence that indicates both a position in queue as well as a hold-off time period. In one example, the access token may be included in a RRC connection reject message. Alternatively, the processing system may transmit the access token in a subsequent message, where the RRC connection reject message may indicate that an access token message may follow.

At optional step 230, the processing system may determine a condition in which the wireless access network can accommodate a connection of the first mobile endpoint device to the wireless access network (e.g., determining that the condition exists/has occurred). In one example, optional step 230 may include determining a number of additional new mobile endpoint device connections/attachments that can be supported at the first cell site, or the like. In addition, in one example, optional step 230 may include determining a range of tokens that may be cleared for use/permitted for use in establishing network connections to the first cell site/base station associated with the processing system. In various examples, the condition may comprise an alleviation of the network impairment, a relinquishment of network resources by one or more other mobile endpoint devices, or a passage of time in excess of a threshold duration. For instance, with respect to the last type of example condition, the wireless access network may allow the first mobile endpoint device its turn regardless of whether the network impairment is alleviated. This could involve blocking or rejecting other mobile endpoint devices, reducing bandwidth of other attached mobile endpoint devices to accommodate the first mobile endpoint device (and possibly other mobile endpoint devices that are waiting to attach, etc.).

At optional step 235, the processing system may broadcast a connection invite. For instance, in one example, the connection invite may include a group classification (e.g., “Group 1 tokens,” “Group 2 tokens,” “Group 3 tokens,” etc.) or a range of one or more access tokens that are authorized for use in connecting to the wireless access network (e.g., cleared for use, permitted for use, having a status changed to being permitted for use, etc., such as may be determined at optional step 230). In one example, the connection invite may be broadcast via a system information block (SIB) of the first cell site/base station associated with the processing system. In one example, the invite may be specific to the first cell site/base station. Alternatively, or in addition, the invite may indicate that the first access token is usable to connect to any of one or more cell sites/base stations, e.g., in a tracking area, a cluster of cell sites/base stations that may maintain a shared priority queue, or the like. For example, cell sites/base stations may each assign access tokens from such a shared queue, and may notify each other or a designated entity, such as a server, of each token assignment. Alternatively, or in addition, the access tokens may represent time stamps indicating when a mobile endpoint device attempted to connect/attach to the wireless access network but was denied/blocked. Thus, different mobile endpoint devices attempting to connect to different cell sites that are denied/block at the same time may have access tokens which may indicate a same priority with respect to a set of cell sites. In this regard, it should be noted that in some example, strict first-in/first-out prioritization may be relaxed to account for potential delay in synchronization between cell sites, to account for the possibility of multiple mobile endpoint devices with the same priority access tokens, and so forth. In one example, the processing system may extend invitations by different classes of mobile endpoint devices. For instance, a connection invite may indicate that ten mobile endpoint devices are now permitted to attempt connections, such as six from class 1, three from class 2, and one from class 3, or the like. Thus, for example, the access tokens may indicate relative priority within each class, where some classes may have additional priority over others and are more likely to obtain connections with reduced delay.

At step 240, the processing system obtains a second network connection request from the first mobile endpoint device, where the second network connection request includes the first access token. For instance, in one example, the second network connection request may be obtained following the first hold-off time period (e.g., the first mobile endpoint device may transmit the second network connection request at an expiration of the hold-off time period). Alternatively, the first mobile endpoint device may transmit the second network connection request in response to the connection invite that is broadcast. Similar to the above, in one example, the second network connection request may comprise a RRC connection request.

At step 245, the processing system establishes a network connection (e.g., completes a network connection procedure) for the first mobile endpoint device (e.g., via the wireless access network and/or or via a first cell site in which the processing system may be deployed), in response to the second network connection request including the first access token. For instance, step 245 may include completing a registration/attach process, performing authentication procedures, establishing a default protocol data unit (PDU) session, e.g., including bearer assignment, channel assignment, physical resource block (PRB) and/or slot assignment, and so forth.

At optional step 250, the processing system may obtain a third network connection request from a second mobile endpoint device, where the third network connection request includes a second access token. For instance, in one example, the third network connection request may comprise another RRC connection request, but from the second mobile endpoint device.

At optional step 255, the processing system may reject the third network connection request in response to at least one of: (a) the second access token being obtained prior to an expiration of a time period in accordance with a second hold-off time period indicated by the second access token, or (b) the second access token is not among a plurality of access tokens designated by the processing system as being authorized for use in connecting to the wireless access network. In one example, the present disclosure may implement both mechanisms, e.g., the second mobile endpoint device must wait for a paging broadcast, or if no paging broadcast is obtained, a network connection request may be permitted after the hold-off time period expires. In one example, it is possible that the processing system may again block/reject the third network connection request but may give a new access token or extend the validity of the second access token to allow the second mobile endpoint device to maintain its priority, e.g., its position in the access queue associated with the first cell site (and which may be implemented/maintained by the processing system).

At optional step 260, the processing system may obtain a fourth network connection request from a third mobile endpoint device, where the fourth network connection request includes a third access token that is associated with a second cell site of the wireless communication network. For instance, in one example, the fourth network connection request may comprise another RRC connection request, but from the third mobile endpoint device newly directed to the first cell site.

At optional step 265, the processing system may map the third access token to a position in an access queue associated with the first cell site.

At optional step 270, the processing system may process the fourth network connection request in accordance with the position in the access queue. For instance, in one example, optional step 270 may include rejecting the fourth network connection request and providing a fifth access token to the third mobile endpoint device (e.g., to replace the fourth access token). For instance, the fifth access token may be associated with an intermediate position in the access queue associated with the first cell site. For example, the third mobile endpoint device may not be immediately allowed to connect/attach, but may be given a higher priority with parity to which the third mobile endpoint device may have been entitled via the second cell site. It may be a shorter or longer time to connect/attach as compared to if the third mobile endpoint device were to attempt to connect/attach to the second cell site, e.g., depending upon the relative levels of network impairment/congestion and/or levels of mobile endpoint device demand at the respective cells, or the like. In another example, optional step 270 may include establishing a second network connection for the third mobile endpoint device, e.g., in response to the position in the access queue determined at optional step 265 being designated for authorization in connecting to the wireless access network.

Following step 245 and/or following any of the optional steps 250-270, the method 200 proceeds to step 295 where the method 200 ends.

It should be noted that the method 200 may be expanded to include additional steps or may be modified to include additional operations with respect to the steps outlined above. For example, various steps of the method 200 may be repeated for the same or different cell site, sector, or the like, e.g., for subsequent network impairment events. In one example, the method 200 may be expanded to further include training one or more network impairment/network load forecasting/prediction models, where step 210 may include the processing system implementing such model(s). In one example, the method 200 may further include detecting that the network impairment is no longer present/occurring, and reverting the first cell site to a non-blocking configuration. In one example, the method 200 may be expanded or modified to include steps, functions, and/or operations, or other features described above in connection with the example(s) of FIG. 1 and/or FIG. 3, or as described elsewhere herein. Thus, these and other modifications are all contemplated within the scope of the present disclosure.

FIG. 3 illustrates a flowchart of an example method 300 for obtaining an access token when a first network connection request is rejected by a wireless access network and transmitting a second network connection request that includes the access token, in accordance with the present disclosure. In one example, steps, functions and/or operations of the method 300 may be performed by a device as illustrated in FIG. 1, such as a mobile endpoint device (e.g., a UE) or collectively via a plurality of devices in FIG. 1, such as a UE 104 or UE 106 in conjunction with any one or more other components in FIG. 1, such as a cell site, a base station, a CU, a DU, a BBU, or the like, NWDAF 192, SMO 190 and/or RIC 199, and so forth. In one example, the steps, functions, or operations of method 300 may be performed by a computing device or system 400, and/or a processing system 402 as described in connection with FIG. 4 below. For instance, the computing device 400 may represent at least a mobile endpoint device in accordance with the present disclosure. For illustrative purposes, the method 300 is described in greater detail below in connection with an example performed by a processing system, such as processing system 402. The method 300 begins in step 305 and proceeds to step 310.

At step 310, the processing system (e.g., of a mobile endpoint device) transmits a first network connection request to a wireless access network, e.g., to a cell site thereof. For instance, in one example, the first network connection request may comprise a RRC connection request message.

At step 320, the processing system obtains an access token for use in a subsequent network connection request (e.g., from the cell site/wireless access network). For instance, the first network connection request may be rejected by the wireless access network in response to a network impairment as discussed above. As further discussed above, the wireless access network (e.g., via the cell site/base station) may transmit a rejection message (e.g., a RRC reject message or the like), which may contain or may be accompanied by the access token.

At optional step 330, the processing system may determine a hold-off time period indicated in the access token. For instance, in one example, the access token may contain an indicator of the hold-off time period, e.g., 30 seconds, one minute, two minutes, etc. For example, the wireless access network may estimate when resources may be available to accommodate a connection/attachment of the mobile endpoint device and may set the hold-off time period accordingly.

At optional step 340, the processing system may obtain a connection invite from the wireless access network. For instance, as mentioned above in connection with optional step 235 of the example method 200, a cell site/base station may transmit an invite containing a particular group class, or a range of one or more access tokens currently authorized to transmit new connection requests to the wireless access network. In other words, the connection invite may include a range of one or more access tokens that are authorized for use in connecting to the wireless access network. Alternatively, or in addition, in one example, the connection invite may include a hold-off time period associated with tokens in the range, e.g., to allow the one or more mobile endpoint devices to prepare to retransmit network connection requests.

At optional step 350, the processing system may determine that the access token is within the range or a group class. For instance, the processing system may compare the access token to the group class or the range to find that it is within the designated range of the group class.

At step 360, the processing system transmits (e.g., to the wireless access network/cell site) a second network connection request in accordance with the access token, where the second network connection request includes the access token. In one example, the processing system may transmit the second network connection request in response to the connection invite that may be obtained at optional step 340. In one example, the transmitting of the second network connection request may further be in response to the determining that the access token is within the range or the group class (e.g., based upon a positive determination at optional step 350). In another example, the processing system may transmit the second network connection request following the hold-off time period as may be determined at optional step 330, or as may be indicated in the connection invite in accordance with one example of the present disclosure.

At step 370, the processing system establishes a network connection (e.g., completes a network connection procedure) with the wireless access network, e.g., when the second network connection request is accepted by the wireless access network in accordance with the access token. For instance, step 370 may include completing a registration/attach process, performing authentication procedures, establishing a default protocol data unit (PDU) session, e.g., including bearer assignment, channel assignment, physical resource block (PRB) and/or slot assignment, and so forth.

Following step 370, the method 300 proceeds to step 395 where the method 300 ends.

It should be noted that the method 300 may be expanded to include additional steps or may be modified to include additional operations with respect to the steps outlined above. For example, various steps of the method 300 may be repeated for the same or different cell site, sector, or the like. In one example, the method 300 may be expanded or modified to include steps, functions, and/or operations, or other features described above in connection with the example(s) of FIG. 1 and/or FIG. 2, or as described elsewhere herein. Thus, these and other modifications are all contemplated within the scope of the present disclosure.

In addition, although not specifically specified, one or more steps, functions, or operations of the example method 200 or the example method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIGS. 2 and 3 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for providing a first access token to a first mobile endpoint device in response to rejecting a first network connection request and obtaining a second network connection request from the first mobile endpoint device that includes the first access token or for obtaining an access token when a first network connection request is rejected by a wireless access network and transmitting a second network connection request that includes the access token, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 406 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 405 for providing a first access token to a first mobile endpoint device in response to rejecting a first network connection request and obtaining a second network connection request from the first mobile endpoint device that includes the first access token or for obtaining an access token when a first network connection request is rejected by a wireless access network and transmitting a second network connection request that includes the access token (e.g., a software program comprising computer-executable instructions) can be loaded into memory 404 and executed by hardware processor element 402 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for providing a first access token to a first mobile endpoint device in response to rejecting a first network connection request and obtaining a second network connection request from the first mobile endpoint device that includes the first access token or for obtaining an access token when a first network connection request is rejected by a wireless access network and transmitting a second network connection request that includes the access token (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system including at least one processor in a wireless access network, a network impairment in the wireless access network;
obtaining, by the processing system, a first network connection request from a first mobile endpoint device;
rejecting, by the processing system, the first network connection request;
providing, by the processing system, a first access token to the first mobile endpoint device;
obtaining, by the processing system, a second network connection request from the first mobile endpoint device, where the second network connection request includes the first access token; and
establishing, by the processing system, a network connection for the first mobile endpoint device, in response to the second network connection request including the first access token.

2. The method of claim 1, further comprising:
broadcasting a connection invite, wherein the establishing of the network connection is in response to the second network connection request being obtained following the broadcasting the connection invite.

3. The method of claim 2, wherein the connection invite is broadcast via a system information block.

4. The method of claim 2, wherein the connection invite includes a range of one or more access tokens that are authorized for use in sending a network connection request to the wireless access network.

5. The method of claim 2, further comprising:
determining a condition in which the wireless access network is able to accommodate a connection of the first mobile endpoint device to the wireless access network, wherein the broadcasting of the connection invite is in response to the determining of the condition.

6. The method of claim 5, wherein the condition comprises:
an alleviation of the network impairment;
a relinquishment of network resources by one or more other mobile endpoint devices; or
a passage of time in excess of a threshold duration.

7. The method of claim 1, wherein the first access token indicates a first hold-off time period, wherein the second network connection request is obtained following the first hold-off time period.

8. The method of claim 7, wherein the first hold-off time period is based upon a level of a congestion condition.

9. The method of claim 1, wherein the network impairment comprises at least one of:
an outage of at least a portion of the wireless access network;
a network congestion condition in the wireless access network; or
an emergency condition in which additional resources of the wireless access network are dedicated to a priority network slice for first responders.

10. The method of claim 1, further comprising:
obtaining a third network connection request from a second mobile endpoint device, wherein the third network connection request includes a second access token; and
rejecting the third network connection request in response to at least one of:
the second access token being obtained prior to an expiration of a time period in accordance with a second hold-off time period indicated by the second access token; or
the second access token being obtained when the second access token is not among a plurality of access tokens designated by the processing system as being authorized for use in connecting to the wireless access network.

11. The method of claim 1, wherein the processing system is associated with a first cell site of the wireless access network, the method further comprising:
obtaining a fourth network connection request from a third mobile endpoint device, wherein the fourth network connection request includes a third access token that is associated with a second cell site of the wireless access network;
mapping the third access token to a position in an access queue associated with the first cell site; and
processing the fourth network connection request in accordance with the position in the access queue.

12. The method of claim 11, wherein the processing comprises:
rejecting the fourth network connection request; and
providing a fifth access token to the third mobile endpoint device, wherein the fifth access token is associated with an intermediate position in the access queue associated with the first cell site.

13. The method of claim 11, wherein the processing comprises:
establishing a second network connection for the third mobile endpoint device, in response to the position in the access queue being designated for authorization in connecting to the wireless access network.

14. The method of claim 2, wherein the connection invite includes a group class of access tokens that are authorized for use in sending a network connection request to the wireless access network.

15. A non-transitory computer-readable medium storing instructions which, when executed by a processing system including at least one processor in a wireless access network, cause the processing system to perform operations, the operations comprising:
detecting a network impairment in the wireless access network;
obtaining a first network connection request from a first mobile endpoint device;
rejecting the first network connection request;
providing a first access token to the first mobile endpoint device;
obtaining a second network connection request from the first mobile endpoint device, where the second network connection request includes the first access token; and
establishing a network connection for the first mobile endpoint device, in response to the second network connection request including the first access token.

16. A method comprising:
transmitting, by a processing system including at least one processor of a mobile endpoint device, a first network connection request to a wireless access network;
obtaining, by the processing system, an access token for use in a subsequent network connection request, wherein the first network connection request is rejected by the wireless access network;
transmitting, by the processing system, a second network connection request in accordance with the access token, where the second network connection request includes the access token; and
establishing, by the processing system, a network connection with the wireless access network when the second network connection request is accepted by the wireless access network in accordance with the access token.

17. The method of claim 16, further comprising:
determining, by the processing system, a hold-off time period indicated in the access token, wherein the processing system transmits the second network connection request following the hold-off time period.

18. The method of claim 16, further comprising:
obtaining, by the processing system, a connection invite from the wireless access network, wherein the transmitting of the second network connection request is in response to the connection invite.

19. The method of claim 18, wherein the connection invite is obtained via a broadcast from the wireless access network.

20. The method of claim 18, wherein the connection invite includes a range of one or more access tokens that are authorized for use in sending a network connection request, the method further comprising:
determining that the access token is within the range, wherein the transmitting of the second network connection request is in response to the determining that the access token is within the range.
